(19) United States
(12) Patent Application Publication
(10) Pub. No.: US 2003/0144026 A1
(43) Pub. Date: Jul. 31, 2003

(54) Electronic equipment having a radio communication module and a method for performing radio communication thereof

(75) Inventors: Toshiyuki Hirota, Tokyo (JP); Koichi Kaji, Saitama-ken (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/352,214

(22) Filed: Jan. 28, 2003

(30) Foreign Application Priority Data
Jan. 29, 2002 (JP) 2002-019459

(51) Int. Cl. H04M 1/00

(52) U.S. Cl. 455/556; 455/90; 455/557; 455/566

(57) ABSTRACT

Electronic equipment including a radio module and a method for performing radio communication among radio equipment to reduce noise interference while transmitting and receiving radio signals. The electronic equipment includes a main unit body, a display unit body rotatably coupled to the main unit body for holding an LCD, a display circuit board provided on a rear portion of the LCD in the display, and an antenna and a radio module provided on the display circuit board as close as possible to each other. Shield material covers the radio module.

### CROSS-REFERENCE TO RELATED APPLICATIONS

This application claims the benefit of priority from Japanese Patent Application No. 2002-19459, filed on Jan. 29, 2002, which is hereby incorporated by reference in its entirety.

### FIELD OF THE INVENTION

The present invention relates to electronic equipment that includes a radio communication module and display and to a method for performing radio communication. More particularly, embodiments consistent with the present invention relate to electronic equipment including a radio module and a display and to a method for performing radio communication among radio equipment to avoid interference with the display and to reduce noise levels in radio signals transmitted between the radio module and an antenna provided near the radio module.

### BACKGROUND OF THE INVENTION

In recent years, a plurality of electronic equipment, such as personal computers and/or printers in an office or in a home, are coupled together on a network. Conventionally, electronic equipment is coupled together by a cable to a local area network (LAN). Recently, cable LAN connections have been replaced by wireless-LAN connections, i.e., by radio communication. To perform radio communication, a radio module is used for transmitting and receiving radio communication data.

For example, Japanese Patent Application Publication 2000-75792 has proposed a personal computer including a radio communication module. The computer taught in the publication is a notebook personal computer in which a radio communication module is installed in a computer body for performing modulation and demodulation processes of radio signals. The signals are received and transmitted through an antenna provided in a display unit body coupled to the computer body.

At the time of transmission, the radio communication module modulates data according to a predetermined format from a CPU or a memory installed in the computer body. The modulated data is transmitted through the antenna in the display unit body. Conversely, at the time of signal reception, received radio waves are demodulated using a predetermined process in the radio communication module for supplying the demodulated data to a CPU or a memory in the computer body.

Thus, a main board of the radio communication module is installed in a main unit body for transmitting and receiving radio data for a radio communication or a wireless LAN connection. The main board of the radio communication module and the antenna are coupled together by signal lines, such as coaxial cables.

To improve radiation characteristics of the transmitted radio data signals through the air, the antenna is placed at as high a position as possible when the electronic equipment is in an operating state. Accordingly, an antenna for a personal computer with a radio communication function is usually installed in a display unit that is rotatably attached to the computer body of the equipment.

In the case of a notebook personal computer with an antenna installed in the display unit of the computer, the cable used to connect the antenna and the radio module circuit board in the computer body is typically about 50-90 centimeters in length. By using a connection cable in the personal computer of such a long length, radio communication signals received and transmitted to and from the antenna are attenuated about 3-6 dB during transmission through the connection cable. Generally, the radio communication signals received by the antenna in the computer are weak. If the weak signals are attenuated in the connection cable, a radio frequency (RF) circuit in the radio module may receive very poor signals. Thus, it is more likely that the communication signals will include noise interference due to high-frequency emission devices, such as the CPU circuit in the computer body. The higher the radio communication frequency used, the weaker the signal transmitted between the antenna and the RF circuit. Consequently, noise interference is increased.

In the case of a notebook personal computer, radio signals received at the notebook's antenna are attenuated by a power loss of about 3-6 dB during transmission through the coaxial cable that connects the antenna and the module because the signals are transmitted at a high frequency. As a result, the radio module has a serious signal attenuation problem. Furthermore, noise interference is another problem. As explained above, a coaxial cable connects the antenna and the radio module together in the computer body. Namely, the coaxial cable is coupled to the radio module located on a main circuit board in the computer body, which includes high-frequency devices, such as a CPU. Since the coaxial cable receives noise interference from high-frequency devices, the transmitting radio communication signals are often easily deteriorated. Thus, the performance of the device is often poor.

### SUMMARY OF THE INVENTION

The present invention intends to solve the above-mentioned problems. Accordingly, the present invention provides electronic equipment, including a radio module and a method for performing radio communication that can reduce the noise level of radio signals transmitted between an interface antenna and a radio module for modulating and demodulating the radio signals. Also, the present invention can reduce interference from the radio signals.

Consistent with the present invention, there is provided electronic equipment comprising: a main unit body installing various devices for operating the electronic equipment; a display unit body rotatably coupled to an edge portion of the main unit body for providing a screen display; a display circuit board provided at a rear portion of the screen display in the display unit body, wherein the display circuit board is connected to the a screen display; a radio module, provided on the display circuit board for modulating and demodulating radio communication data signals supplied to and from one of the devices installed in the main unit body; and an antenna provided in the vicinity of the radio module, such as on the display unit body, for transmitting and receiving the radio communication data.

Also consistent with the present invention, there is provided a radio communication method for use with electronic equipment comprising a main unit body, a display unit body rotatably coupled to the main unit body for holding a screen display, a display circuit board provided in the display unit body, a radio module provided on the display circuit board for processing data of radio signals, and an antenna for receiving and transmitting radio signals to and from the equipment. The method comprises: receiving radio signals through the antenna; demodulating the received radio signals in the radio module; and transmitting the demodulated signals into the main unit body for processing through a USB line.

Further consistent with the present invention, there is provided a radio communication method for use with electronic equipment comprising a main unit body, a display unit body rotatably coupled to the main unit body for holding a screen display, a display circuit board provided in the display, and an antenna for receiving and transmitting radio signals. The methods comprises: supplying transmission data processed in the main unit body to a radio module installed on the display circuit board through a USB line; modulating the supplied transmission data in the radio module for converting the data into a signal within a radio transmission frequency band; and transmitting the radio signal through the antenna.

### BRIEF DESCRIPTION OF THE DRAWINGS

The accompanying drawings, which are incorporated in and constitute part of this specification, illustrate various embodiments and/or features of the invention and together with the description, serve to explain the invention. Wherever possible, the same reference numbers will be used throughout the drawings to the same or like parts. In the drawings:

FIG. 1 is a perspective view of an exemplary configuration for a notebook personal computer in which methods and apparatus consistent with the present invention may be implemented.

FIG. 2 is a functional block diagram of an exemplary circuit diagram for radio communication in which methods and apparatus consistent with the present invention may be implemented.

FIG. 3 depicts a rear elevation view of the personal computer illustrated in FIG. 1 with the rear cover of a display unit body.

FIG. 4 is a functional block diagram of an exemplary circuit diagram for a radio module illustrated in FIG. 2.

FIG. 5 is a perspective view of an exemplary configuration for a foldable mobile phone as another embodiment consistent with the present invention.

### DETAILED DESCRIPTION

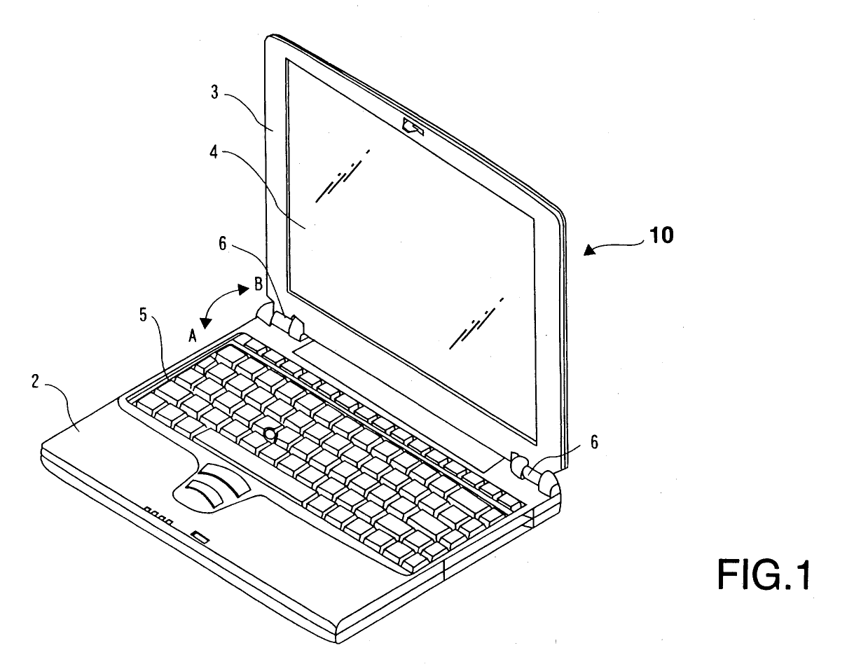

Reference will now be made in detail to the exemplary embodiments of the invention, examples of which are illustrated in the accompanying drawings. Wherever possible, the same reference numbers will be used throughout the drawings to refer to the same or like parts. FIG. 1 illustrates a notebook personal computer 10 consistent with the invention. The personal computer 10 includes a main unit body 2 and a display unit body 3. The display unit body 3 holds a screen display 4, such as an LCD panel, so that a displaying area is visible. A keyboard unit 5 is provided on an upper surface of the main unit body 2. One elongated side edge of the display unit body 3 is coupled to one elongated side edge of the main unit body 2 through hinge units 6. Thus, the display unit body 3 rotatably moves through the hinge 6 along A-B arrow directions to and from a display open position and a display closed position. When the display unit body 3 is closed, it covers the upper surface of the main unit body 2 to protect the keyboard unit 5.

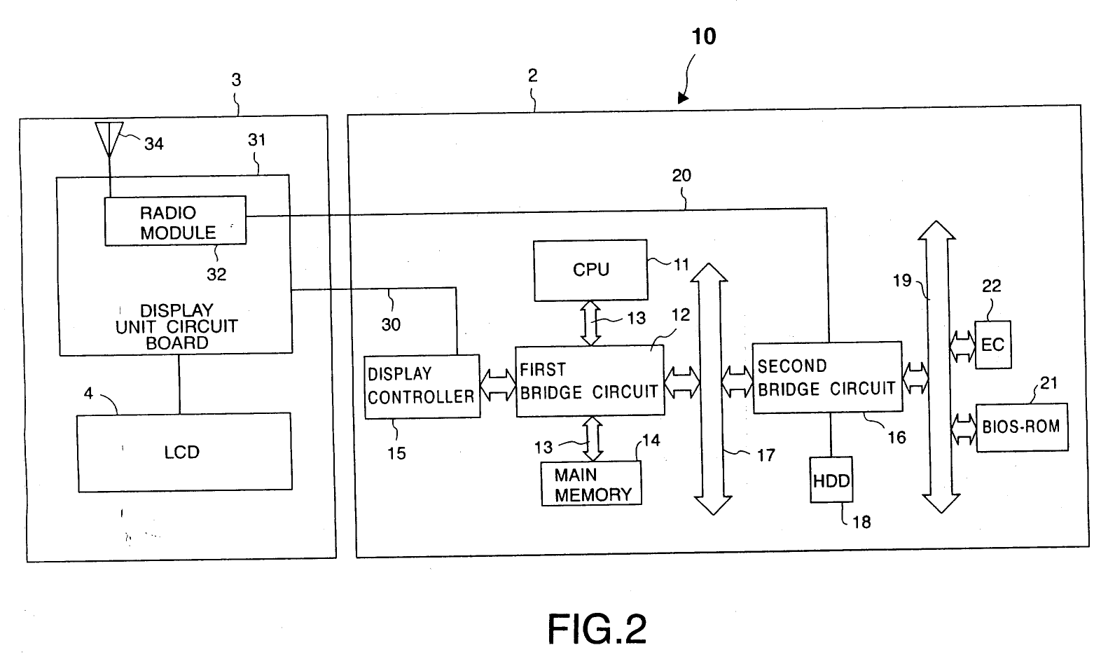

In general, operation of the personal computer is accomplished by electronic components located within the main unit body 2. For example, as illustrated in FIG. 2, the main unit body 2 of the personal computer 10 includes a CPU 111 for controlling operational execution and data processing of the computer 10; a main memory 14 for storing for example, an Operating System (OS), a BIOS, event utility software, various device drivers, and processed data; a display controller 15; an HDD 18 as a storing/reproducing apparatus for data; and an embedded controller (EC) 20 for installing a plurality of register groups which may be read/written by the CPU 11. The main memory 14 includes, for example, a plurality of dynamic random access memories (DRAM).

The CPU 11 and the main memory 14 are respectively connected to a first bridge circuit 12 through a CPU local bus 13. The CPU local bus 13 includes a data bus of 64 bits in width. Usually, the first bridge circuit 12 and the main memory 14 are coupled using a memory bus. However, the CPU local bus 13 is used in the presently illustrated embodiment. Further, a display controller 15 is also connected to the first bridge circuit 12 through a data bus. The display controller 15 is coupled through a cable 30 to the screen display 4, which may be provided as a liquid crystal display (LCD) provided in the display unit body 3.

In the main unit body 2, the first bridge circuit 12 is coupled to a second bridge circuit 16 through a first bus 17. The first bus 17 includes a data bus of 32 bits in width. The hard disk drive (HDD) 18 is connected to the second bridge circuit 16. Further, the embedded controller (EC) 20 and a BIOS-ROM 21 are coupled to the second bridge circuit 16 through a second bus 19. The second bus 19 includes a data bus 16 bits in width.

The first bridge circuit 12 is a bridge LSI for coupling between the CPU local bus 13 and the first bus 17, and it functions as one of the bus master devices for the first bus 17. The first bridge circuit 12 performs various functions, such as a function for converting bus width including data and addresses between the CPU local bus 13 and the first bus 17, and a function for controlling the main memory 14 through a memory bus. Further, the first bridge circuit 12 may function as a display controller for transmitting display data to the display controller 15 coupled through the first bridge circuit 12. The first bus 17 is a clock synchronization type input/output bus. Thus, whole cycles on the first bus 17 synchronize with a first bus clock. The first bus 17 further includes a time divisionally used address/data bus.

The second bridge circuit 16 is a bridge LSI for coupling between the first bus 17 and the second bus 19. Further, the second bridge circuit 16 installs an intelligent drive electronics device (IDE) controller for controlling the HDD 18. The second bridge circuit 16 further includes a connecting port for a universal serial bus (USB) 20 and a USB controller. The second bridge circuit 16 is coupled to the BIOS-ROM 21 and the EC 22 through the second bus 19.

The BIOS-ROM 21 stores system programs of functional execution routines for accessing various hardware provided in the personal computer 10. When the personal computer 10 is starting up, the BIOS program is read out. The BIOS program is stored in a non-volatile memory, such as a flash ROM, in the personal computer 10. The EC 22 installs a plurality of register groups that may be read/written by the CPU 11. By using these register groups, it is possible to communicate between the CPU 11 and the devices coupled to the EC 22. The EC 22 may further function as a keyboard controller (KBC).

A display circuit board 31 is located in the display unit body 3 and is connected to the second bridge circuit 16 through the USB 20. The USB 20 is a communication interface used for transmitting and receiving data by radio communication. Thus, the received data at the radio module 32 in the display unit body 3 is supplied to the main unit body 2 through the USB 20. Further, the display circuit board 31 provided in the display unit body 3 is connected to the display controller 15 in the main unit body 2 through a low voltage differential signaling line (LVDS) 30. Thus, display data supplied from the display controller 15 is inputted into the display circuit board 31 in the display unit body 3 through the LVDS line 30.

The display circuit board 31 includes a timing circuit for outputting to the liquid crystal display (LCD) 4, shift registers, a latch circuit and/or a D/A converter. Thus, the display circuit board 31 generates gradation voltages corresponding to gradations of display data for every pixel and supplies the voltages to the LCD 4.

The display circuit board 31 further includes a radio module 32 for performing radio communication. The radio module 32 modulates and demodulates radio waves and is connected to an antenna 34. The radio module 32 functions as an interface for transmitting and receiving radio waves to and from outside equipment. Thus, antenna 34 transmits signals supplied from the radio module 32 and also supplies radio waves received from outside to the radio module 32. The radio module 32 is addressed below in further detail. The following discusses an embodiment of the present invention wherein the radio module 32 operates according to the Bluetooth radio communication standard.

Bluetooth is a radio communication standard used for communication over a short distance, such as less than 10 meters. The standard uses an industry science medical band (ISM) of 2.4 GHz. Since Bluetooth applies a frequency hopping system as a spectrum diffusion system, it is thus possible to connect a maximum of eight apparatus by time-division multiplexing. Although the radio module in the present embodiment is discussed in the context of the Bluetooth standard, it is also possible for electronic equipment consistent with the present invention to apply another radio module, such as a wireless LAN, for example.

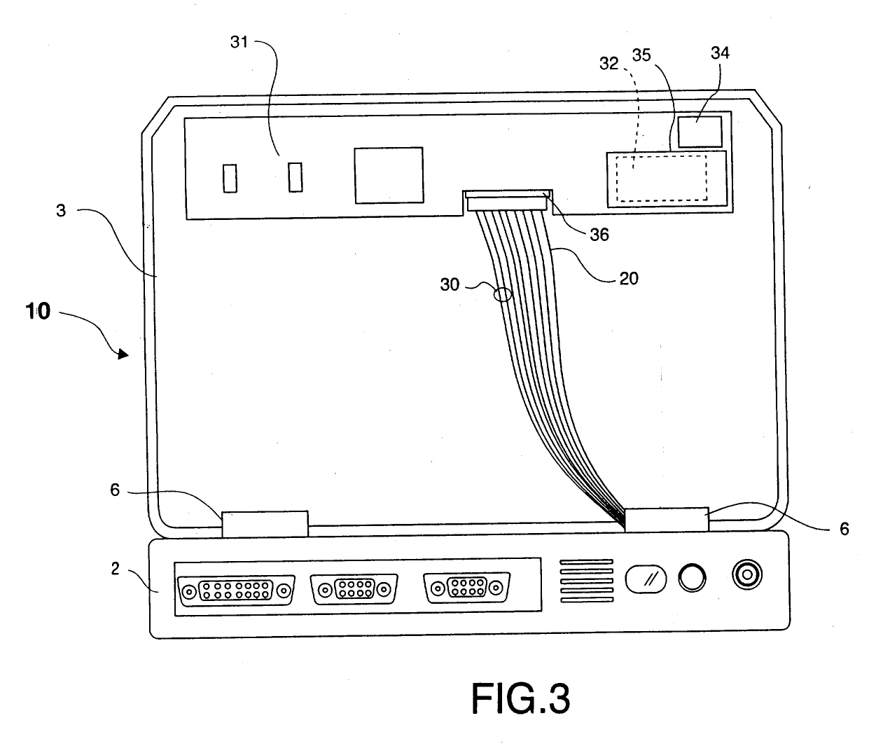

As illustrated in FIG. 3, the display circuit board 31 is located on the rear side of LCD unit 4 that is fixed to the display unit body 3. In the display circuit board 31, the radio module 32 functions as the interface for transmitting and receiving radio communications. Circuits that emit electromagnetic radiation, such as the radio module 32 in the display circuit board 31, are shielded with a shielding material 35 to avoid electromagnetic interference with the LCD unit 4. The display circuit board 31 allows the antenna 34 to be located on an upper portion of the display unit body 3 during an open state of the display. As illustrated in FIG. 3, the display circuit board 31 includes a connector unit 36. Many data lines, such as the USB 20, the LVDS line 30, and an electric power source line, extend from the main unit body 2 and connect to the connector unit 36 of the display circuit board 31.

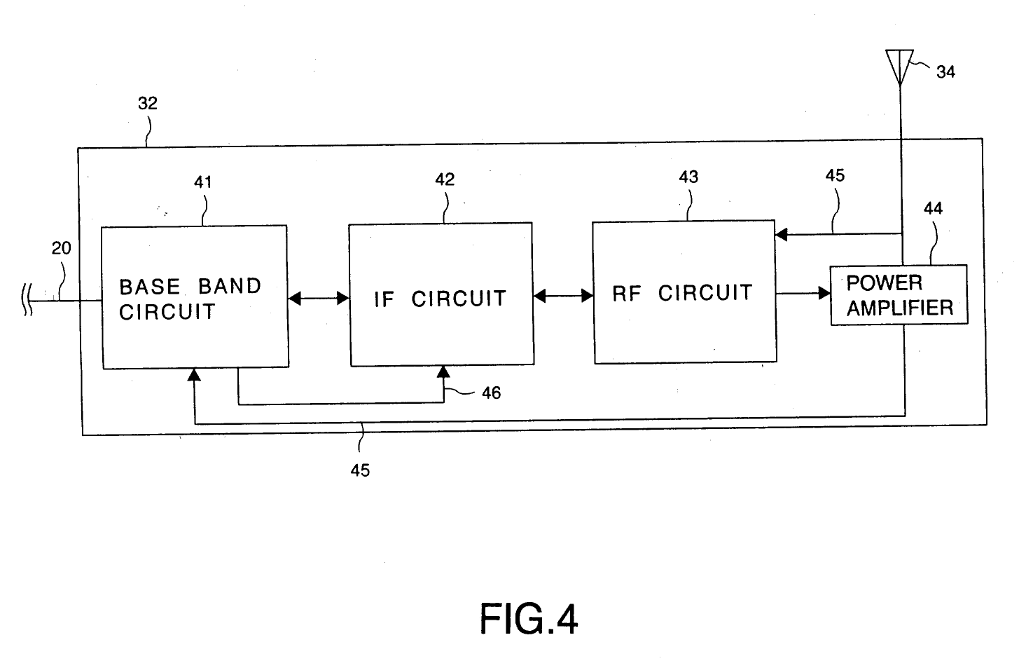

FIG. 4 illustrates an example of a circuit construction of the radio module 32. The radio module 32 includes a base-band circuit 41 for transmitting and receiving data to and from the devices installed in the main unit body 2 through the USB 20; an intermediate frequency (IF) circuit 42 connected to the base-band circuit 41; a radio frequency (RF) circuit 43 connected to the IF circuit 42; and a power amplifier 44 for amplifying output signals from the RF circuit 43.

During radio transmission, the base-band circuit 41 converts transmitting signals supplied through the USB 20 into low frequency data at the rate of several to several tens MHz and performs various processes, such as a control process for arranging the signals into transmitting data based on a communication protocol, a process for correcting errors, and a process for digital signals according to commands supplied within the personal computer 10. Conversely, at the time of radio reception, the base-band circuit 41 converts signals of several hundred MHz that are received from IF circuit 42 into signals of several tens MHz, and further converts the converted signals into output signals to the USB 20.

IF circuit 42 converts the output signals from the base-band circuit 41 into an intermediate frequency of several hundred MHz, and supplies them to the RF circuit 43. Conversely, IF circuit 42 converts received signals supplied from the RF circuit 43 into the intermediate frequency of several hundreds MHz to the base-band circuit 41. RF circuit 43 converts output signals from the IF circuit 42 into a transmitting signal of the 2.4 GHz band and supplies it to the power amplifier 44.

Power amplifier 44 amplifies the output signals from the RF circuit 43 and transmits the amplified output signal through the antenna 34. If the output level of the transmitting signal from RF circuit 43 has not reached a predetermined value, power amplifier 44 supplies instruction signals to the IF circuit 42 through a signal line 45 and the RF circuit 43 to constantly maintain the transmitting output at the predetermined value by controlling gain of a pre-amplifier (not shown) provided in IF circuit 42. In accordance with the instruction signal from the power amplifier 44, base-band circuit 41 supplies an instruction signal to the IF circuit 42 through a signal line 46 to amplify the transmitted output by the pre-amplifier.

The signal transmitted between the RF circuit 43 and the antenna 34 is a high frequency signal and may be weak due to noise. Further, power loss arises between the antenna 34 and the RF circuit 43. Consequently, it is desirable to shorten the signal lines between the RF circuit 43 and the antenna 34 as much as possible to reduce noise and interference. In accordance with the present embodiment, as illustrated in FIG. 3, the radio module 32 is installed in the display circuit board 31 and is positioned higher when the display unit body 3 is in an open state. Further, the antenna 34 is located near the radio module 32 to shorten the distance between them. Thus, according to the present embodiment, it becomes possible to eliminate interference, such as noise, to the antenna receiving signal level as much as possible because antenna 34 is positioned at the highest location on the display unit body 3 while the personal computer 10 operates. Further, the antenna 34 is located a very short distance from the radio module 32.

In this embodiment, the radio module 32 is installed on the display circuit board 31 located on an upper portion of the display unit body 3. Further, the radio module 32 and devices provided in the main unit body 2 are coupled together by the USB line 20. According to these configurations, it becomes possible to connect the radio module 32 and the antenna 34 with a very short signal cable of, for example, several centimeters to eliminate noise interference. Consequently, the attenuation of the modulated radio signal may be controlled to up to about 1 dB. Similarly, the display circuit board 31 in the display unit body 3 and a circuit board provided in the main unit body 2 are connected through USB line 20. Since the USB signal is comprised of digital signals of [1] and [0] bits, the signal is not attenuated by noise. For this reason, even when the signals are transmitted a long distance, it is unlikely that noise interference will attenuate the signal.

In an embodiment consistent with the present invention, base-band circuit 41, IF circuit 42, and RF circuit 43 are installed on the radio module 32 in the display circuit board 31. However, it is also possible to locate only the RF circuit 43 on the display circuit board 31 to generate a high frequency signal of 4 GHz because the output signal from the IF circuit is a signal of several hundreds MHz and has a low noise level and a low power loss in comparison with the output signals of RF circuit 43. Further, it is also possible to provide both IF circuit 42 and RF circuit 43 on the display circuit board 31 and to install the baseband circuit 41 into the main unit body 2 because the output signal from the base-band circuit 41 is about several tens MHz and has a low noise level and low power loss in comparison with the output signal of several hundreds MHz from the IF circuit 42 and the output signal of 2.4 GHz from the RF circuit 43.

In the embodiment illustrated in FIG. 3, the antenna 34 is also installed on the display circuit board 31. Additionally, it is possible to provide the antenna 34 near the display circuit board 31. Thus, it is desirable for electronic equipment performing radio communications to include an antenna 34 located at an uppermost position during the use of the electronic equipment to improve data radiation characteristics. It is thus desirable to install the antenna in an upper position on the rotatable display unit body 3. Further, in accordance with embodiments consistent with the present invention, it is possible to shorten a distance between the antenna 34 and the radio module 32 by locating the radio module 32 for performing radio communication on the display circuit board 31. Consequently, the power loss of signals between the antenna 34 and the radio module 32 is reduced. Thus, in an embodiment consistent with the present invention, it becomes possible to achieve stable transmission and reception of data by providing the radio module 32 for performing modulation and demodulation of radio signals on the display circuit board 31 in the display unit body 3.

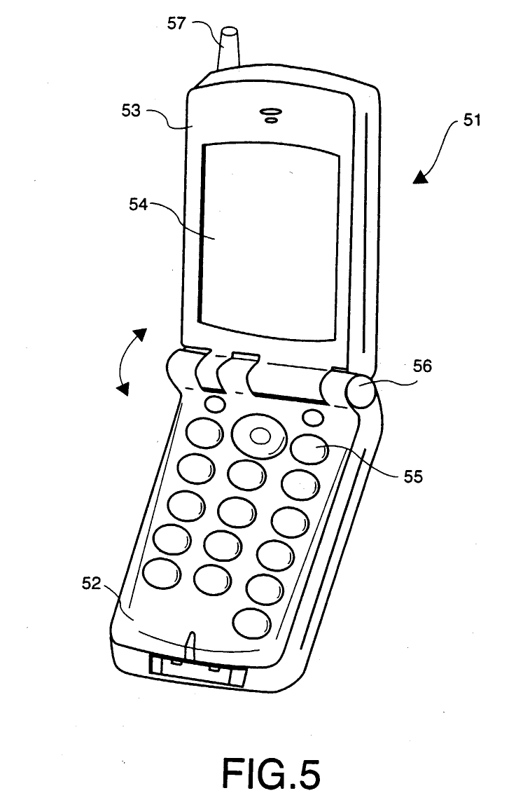

FIG. 5 illustrates a second embodiment consistent with the present invention. With reference to FIG. 5, a foldable mobile phone 51 includes a mobile phone body unit 52 and a display unit body 53. The display unit body 53 is rotatably coupled to the phone body unit 52 through hinge portions 56. Additionally, the display unit body 53 includes an LCD 54 for displaying various data, and the phone body unit 52 includes a group of keys 55 as an input interface for dialing.

When the mobile phone 51 is used as a telephone, the phone body unit 52 or the display unit body 53 is rotated and opened along the direction of the bi-directional arrow to make the key group 55 and LCD 54 useable. In consideration of electric wave directivity, antenna 57 is located at a high position during use of the mobile phone 51. Further, the antenna 57 is located on the rear-side of the display unit body 53 to keep the antenna 57 away from a human body as much as possible. In this embodiment, a radio module (not shown) is installed in the display unit body 53 to modulate and demodulate radio signals.

If the radio module is located inside the phone body unit 52 of the mobile phone 51, it generates a large power loss while transmitting and receiving signals between the antenna 57 and the radio module because the signal line from the antenna must extend a long distance. On the contrary, this embodiment, which is consistent with the present invention, includes the radio module inside the display unit body 53 to reduce noise interference between the antenna 57 and the radio module. It is also possible to increase the strength of the transmitting and receiving signals.

As explained above, the described electronic equipment and method for performing radio communication may reduce noise interference while transmitting and receiving signals between the antenna 57 as an interface for radio communication to and from radio equipment and a radio module for modulating and demodulating the radio signal. Thus, embodiments consistent with the present invention provide electronic equipment with a higher clarity of transmission and reception signals.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. Electronic equipment, comprising:
a main unit body with various devices for operating the electronic equipment;
a display unit body rotatably coupled to an edge portion of the main unit body for providing a screen display;
a display circuit board provided at a rear portion of the screen display in the display unit body, wherein the display circuit board is connected to the screen display;
a radio module provided on the display circuit board for modulating and demodulating radio communication data signals supplied to and from one of the devices installed in the main unit body; and
an antenna provided in the vicinity of the radio module, on the display unit body, for transmitting and receiving the radio communication data.

2. The electronic equipment according to claim 1, wherein:
the display unit body includes a surface for providing a keyboard unit;
the display unit body can be rotated to cover the surface to protect at least the keyboard unit while the electronic equipment is inactive;
the display circuit board is provided in the display unit body so it is positioned at an upper portion of the display unit body while the electronic equipment is in operation; and
the antenna is provided near the radio module on the display circuit board to minimize a length of a signal cable coupled therebetween.

3. The electronic equipment according to claim 1, wherein:
the various devices installed in the main unit body include at least a CPU, a bridge circuit coupled to the CPU, and a display controller coupled to the CPU through the bridge circuit;
the display circuit board in the display unit body is coupled to the display controller in the main unit body through a cable; and
the radio module on the display circuit board is coupled to the bridge circuit in the main unit body through a USB line to reduce attenuation of transmitted signals.

4. The electronic equipment according to claim 1, wherein the radio module is covered by a shield material to shield the antenna from electromagnetic radiation from the radio module.

5. The electronic equipment according to claim 3, wherein the display circuit board includes a connector unit for coupling the cable and the USB line.

6. The electronic equipment according to claim 3, wherein:
the radio module includes an intermediate frequency generating circuit for converting a transmitting frequency for transmitting signals using the antenna into a lower frequency than the transmitting frequency; and
a high frequency generating circuit for converting the signals generated in the intermediate frequency generation circuit into a transmission signal for transmission through the antenna.

7. The electronic equipment according to claim 5, wherein:
the radio module includes a base-band circuit coupled to the bridge circuit in the main unit body through the USB line.

8. The electronic equipment according to claim 6, wherein at least the high frequency generating circuit is provided on the display circuit board.

9. A radio communication method for use with electronic equipment comprising a main unit body, a display unit body rotatably coupled to the main unit body for holding a screen display, a display circuit board provided in the display unit body, a radio module provided on the display circuit board for processing of radio signals, and an antenna for receiving and transmitting radio signals to and from the equipment, the method comprising:
receiving radio signals through the antenna,
demodulating the received radio signals in the radio module; and
transmitting the demodulated signals into the main unit body for processing through a USB line.

10. A radio communication method for use with electronic equipment comprising a main unit body, a display unit body rotatably coupled to the main unit body for holding a screen display, a display circuit board provided in the display, and an antenna for receiving and transmitting radio signals, the method including:
supplying transmission data processed in a main unit body to a radio module installed on the display circuit board through a USB line;
modulating the supplied transmission data in the radio module for converting the data into a signal within a radio transmission frequency band; and
transmitting the radio signal through the antenna.
